(19) United States
(12) Patent Application Publication
(10) Pub. No.: US 2017/0141419 A1
(43) Pub. Date: May 18, 2017

(54) AEROSPACE FUEL CELL CONTROL SYSTEM

(71) Applicant: Parker-Hannifin Corporation, Cleveland, OH (US)

(72) Inventors: Peter E. Wu, Lake Forest, CA (US); Michel Loignon, Laguna Beach, CA (US); Brian S. Burgess, Burleson, TX (US); Daniel C. Massie, Mission Viejo, CA (US); Thomas C. O'Brien, Huntington Beach, CA (US)

(21) Appl. No.: 15/354,458

(22) Filed: Nov. 17, 2016

Related U.S. Application Data
(60) Provisional application No. 62/256,343, filed on Nov. 17, 2015.

(51) Int. Cl. H01M 8/04791; A62C 3/08; H01M 16/00; A62C 2/04; H01M 8/04828; H01M 8/04992

(52) U.S. Cl. CPC H01M 8/04805; H01M 8/0491; H01M 8/04992; H01M 16/006; A62C 2/04; A62C 3/08; H01M 2250/20

(57) ABSTRACT

A fire suppression system for producing oxygen-depleted air includes a fuel cell stack formed from a plurality of fuel cells for providing power to an associated load, and a controller coupled to the plurality of fuel cells, wherein the controller is configured to regulate current output from the plurality of fuel cells to maintain a prescribed percentage level of oxygen depleted air in an exhaust stream of the plurality of fuel cells. Further, a method for maintaining an updated polarization curve for a fuel cell includes commanding step-and-hold air flow commands and associated electrical current limit commands to the fuel cell system. Upon the fuel cell reaching each successive step-and-hold steady state condition, electrical current and voltage pairs are stored and plotted to form the real-time polarization curve. Upon characterizing the fuel cell polarization curve, a maximum power line is projected at the knee of the polarization curve, above which point the system is not permitted to operate without augmentation from the battery storage device. A maximum fuel cell power capability is continually prognosticated during run-time and is used to maximize operational robustness.

### RELATED APPLICATION DATA

This application claims priority of U.S. Provisional Application No. 62/256,343 filed on Nov. 17, 2015, which is incorporated herein by reference in its entirety.

### TECHNICAL FIELD

The present invention relates to aerospace fuel cell power control systems and, more particularly, to a system and method for controlling operation of one or more fuel cells and/or fuel cell stacks using battery fill-in power as a means to control the oxygen content of the exhaust stream using current limiting to trigger battery power fill-in power and/or to actively probe for the mass transport loss regions of the polarization curve to prevent actual current from exceeding the knee of the polarization curve.

### BACKGROUND

Fuel cell systems typically contain fuel cell stacks that are comprised of a number of individual fuel cells. The individual fuel cells and the stacks are usually supplied with reactant streams in parallel, with a hydrogen-containing fuel stream being supplied to the anode, and an oxidant stream, such as air or oxygen, being supplied to the cathode to produce output power.

One problem with conventional fuel cell control systems is they fail to actively predict the mass transport loss region boundary, and can allow a load to draw more electrical power than the fuel cell's current capability, resulting in loss of electrical power to critical systems, timely reset/reboot to bring the system back on-line and potential damage to the fuel cell. Furthermore, identifying when the fuel cell is unable to deliver a given power level to the load depends on a number of factors that are not deterministic, including a state of health of the fuel cell. Running a fuel cell into its mass transport loss region not only damages the stack, but can cause the system under operation to fail its intended function.

### SUMMARY

In accordance with one aspect of the present disclosure, there is provided a system and method for controlling the oxygen content in an exhaust of a fuel cell to achieve oxygen-depleted air that can be used for fire prevention. More particularly, the system and method in accordance with the present disclosure achieve a target oxygen content in the fuel cell exhaust by regulating a current output by the fuel cell. Battery fill-in may be used to supplement fuel cell power during periods in which the power demand on the fuel cell varies. This has the distinct benefit of allowing a more precise oxygen content stream during transient airflow conditions.

In accordance with another aspect of the present disclosure, provided is a system and method for revising the polarization curve of a fuel cell modelled in the controller in order to prognosticate the instantaneous condition of each fuel cell stack due to many conditions such as: intermittent air contamination, hydrogen dilution, poor water balance and humidity control, poor temperature control, sensor delay, drift, inaccuracy, catalyst deterioration and other unforeseen events. More particularly, for a given air flow the current and voltage of the fuel cell are recorded during a forced pseudo steady state operation. A prediction is made to where the mass transport loss region's boundary (Knee-of-the curve) is without having to operate there. A determination is made if the data is not indicative of the factory condition. If the data is not indicative of the factory specification, a new estimation is made as to where the mass transport loss region boundary is, and the fuel cell will not be allowed to operate beyond that point. As the electrical demand changes, the process is repeated with new pseudo steady state data. The mass transport loss region's boundary can be repeatedly re-identified, and the polarization curve model for the fuel cell can be revised. This prognostic approach prevents the fuel cell operating in the region beyond between its true “mass transport loss threshold”, but below its factory fresh mass transport loss region threshold. It assumes the conditions of the fuel cell have degraded from its optimal un-degraded factory condition

According to one aspect of the invention, a fire suppression system for producing oxygen-depleted air includes: a fuel cell stack formed from a plurality of fuel cells for providing power to an associated load; and a controller coupled to the plurality of fuel cells, wherein the controller is configured to regulate current output from the plurality of fuel cells via current limiting devices within the pluralities of Power Converters to maintain a percentage of oxygen in an exhaust of the plurality of fuel cells at a prescribed level to produce oxygen-depleted air.

In one embodiment, the controller is configured to maintain a stoichiometric ratio at the plurality of fuel cells to a prescribed level.

In one embodiment, the controller is configured to maintain the ratio between 1.2 and 2.0.

In one embodiment, the system includes a DC/DC power converter coupled between a power output of the fuel cell stack and the associated load, the DC/DC power converter including a current limiter to limit a current output from the fuel cell stack, wherein the controller is configured to provide a control signal to the DC/DC power converter to limit an amount of current drawn by the associated load from the fuel cell stack.

In one embodiment, the controller is further configured to regulate air flow into the plurality of fuel cells to provide a variable power output to the associated load.

In one embodiment, the system includes at least one of a compressor or a bleed inlet valve for regulating air flow through the plurality of fuel cells, wherein the controller is configured to provide a control signal to the at least one of the compressor or the bleed inlet valve to regulate the air flow.

In one embodiment, the system further includes an energy storage device, and the controller is configured to: calculate at least one of a maximum power or maximum current the fuel cell stack is capable of supplying to the associated load; and selectively receive additional power or current from the energy storage device when the associated load seeks an amount of power or current greater than the maximum power or maximum current the fuel cell stack is capable of supplying.

In one embodiment, the fuel cell stack and the energy storage device are coupled in parallel to a direct current to direct current (DC-DC) converter that is coupled to the associated load.

In one embodiment, the associated load comprises one or more aircraft systems.

According to another aspect of the disclosure, a method for providing oxygen depleted air from a fuel cell stack formed from a plurality of fuel cells, the method including regulating current output from the plurality of fuel cells to maintain a percentage of oxygen in an exhaust of the plurality of fuel cells at a prescribed level to produce oxygen-depleted air.

In one embodiment, regulating includes maintaining a stoichiometric ratio of the plurality of fuel cells to a prescribed level.

In one embodiment, maintaining includes maintaining the ratio between 1.2 and 2.0.

In one embodiment, the method includes regulating air flow into the plurality of fuel cells to provide a variable power output to the associated load.

In one embodiment, the method includes: calculating at least one of a maximum power or maximum current the fuel cell stack is capable of supplying to the associated load; and selectively receiving additional power or current from an energy storage device when the associated load seeks an amount of power or current greater than the maximum power or maximum current the fuel cell stack is capable of supplying.

In one embodiment, the associated load comprises one or more aircraft systems.

According to another aspect of the disclosure, a method for revising a polarization curve model for a fuel cell includes: a) providing a prescribed air flow through the fuel cell satisfying a load with a combination of the fuel cell and storage device; b) upon the fuel cell reaching a steady state condition, measuring a current and voltage output by the fuel cell for the prescribed air flow; c) determining if the measured voltage and current is indicative of a knee of a curve; and d) upon the measured voltage and current not being indicative of a knee of a curve, incrementing the prescribed air flow through the fuel cell and repeating steps b) though d).

In one embodiment, measuring the current and voltage output further includes: storing at least one additional current and voltage point; curve-fitting a new polarization curve using the at least one additional current and voltage point; and preventing the fuel cell from delivering beyond the knee of the curve.

In one embodiment, upon multiple measured voltage and current points defining a knee of a curve, revising a location of the knee in the polarization curve based on the multiple measured voltage and current points defining the knee of a curve.

In one embodiment, determining if the multiple measured voltage and current points define a knee of a curve includes concluding the multiple measured voltage and current points are indicative of a knee of a curve when a plot of each measured voltage and current point changes slope of the polarization curve by a prescribed value.

In one embodiment, the slope of the polarization curve is less than −1 volts/amp.

The foregoing and other features of the invention are hereinafter described in greater detail with reference to the accompanying drawings.

### BRIEF DESCRIPTION OF THE FIGURES

FIG. 1 is a block schematic drawing of an exemplary system in accordance with aspects of the present invention.

FIG. 2 is another exemplary polarization curve illustrating various flow rates.

FIG. 3 is a graphical representation of a polarization curve illustrating the relationship between fuel cell voltage and current density.

FIG. 4 is a block schematic diagram illustrating a current limitation process based on chemistry of the Proton Exchange Member and abundance of H₂ and O₂ reactants.

FIG. 5 is a block schematic drawing of an exemplary system in accordance with aspects of the present invention pertaining to calculated current limitations.

FIG. 6 is a block schematic drawing of an exemplary system in accordance with aspects of the present invention illustrating battery augmentation at the point of current regulation.

FIGS. 7A-7D are exemplary graphical representations that illustrate poor voltage triggering voltage-based fill-in.

FIGS. 8-12 and 14 are exemplary methods in accordance with aspects of the present invention.

FIG. 13 is a graph illustrating an exemplary polarization curve.

FIG. 14 is a flow chart illustrating an exemplary method in accordance with an aspect of the invention.

### DESCRIPTION OF THE PREFERRED EMBODIMENTS

The following description of the preferred embodiments of the invention is not intended to limit the invention to these preferred embodiments, but should be considered illustrative to enable a person skilled in the art to make and use the claimed invention.

Battery “fill-in” control for a fuel cell stack is triggered and metered by a family of computations. These computations predict the fuel cell stack's instantaneous capability to deliver power, current and voltage to prevent the fuel cell from exceeding this power limit. Thus, the present invention takes an observational-based understanding (e.g., during a step load battery fill-in is needed) to a model-based understanding (e.g., battery fill-in is necessary when the fuel cell computations indicate that the fuel cell and/or fuel cell stack cannot provide more than a certain power (e.g., X kilowatts (kW) required by the load).

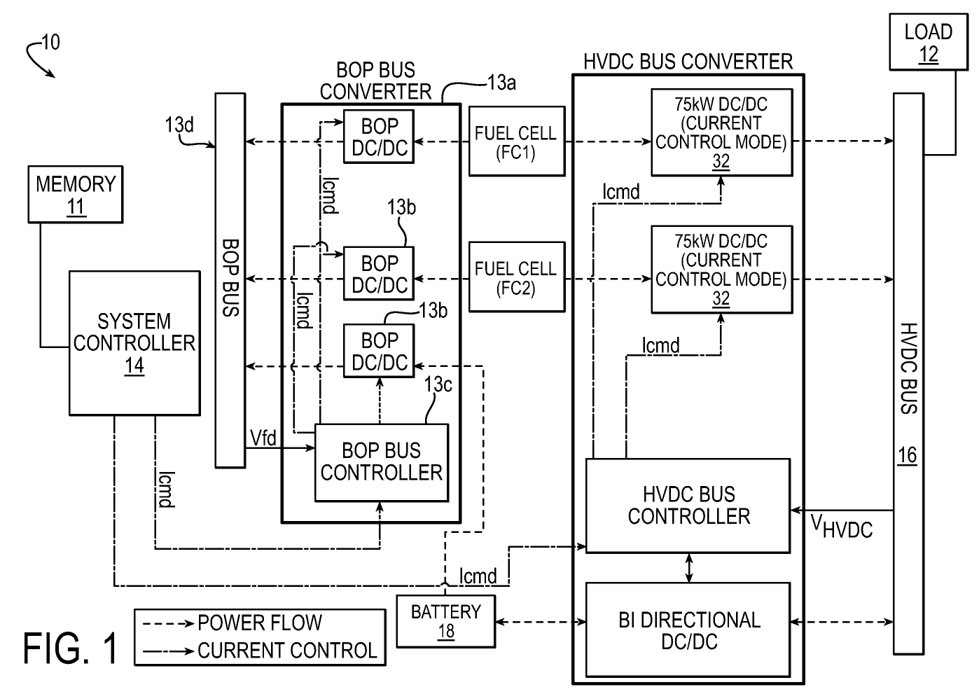

Referring to FIG. 1, an exemplary aerospace power control system 10 is illustrated. In this system, two fuel cell stacks (FC1 and FC2) are illustrated, where the fuel cell stack voltage is approximately 150 Volts at maximum load and 240 Volts at minimum load. These voltages are merely exemplary and it is understood that other voltage ranges are possible.

The fuel cell stacks provide power to a load 12 and to a balance of plant (BOP) bus 13d, the BOP including equipment associated with operation of the generation of power from the fuel cells. In this regard, the BOP includes a BOP bus converter 13a having a plurality of DC/DC converters 13b for limiting current provided by the fuel cells, and a BOP bus controller 13c. The BOP bus controller 13c, based on commands from a system controller 14, controls the DC/DC converters 13b to regulate the power provided to a BOP bus 13d.

A fuel cell stack operating at partial load is susceptible to voltage drops when a large electrical load instantaneously appears. During transient power demand, the relatively slow changing air stream will cause the fuel cell stack (FC1, FC2) to be dragged away from its “Ohmic” region and towards its “Mass transport loss” region. Operating in the Mass transport loss region can result in fuel cell damage and/or shutdown. As designed, DC/DC converter HVDC01 is configured to produce +/−270 volts until the fuel cell stack has been pulled down to 130 Volts, after which it will cease to convert. With insufficient oxygen or excess electrical draw, the low voltage will result in the fuel cell stack (FC1, FC2) being well out of its intended “Ohmic” region.

Aspects of the present invention seek to design robustness against fuel cell voltage drop (potentially resulting in fuel cell stack driven into shutdown) during large power transients. In such cases, a load 12 can be added to the fuel cell stack without warning, and produce shutdowns due to voltage dips. As used herein, the load 12 may be any type of electrical load from one or more aircraft systems. Exemplary aircraft systems include cockpit controls, communication systems, air systems, connecting linkages, engine controls, and operating mechanisms to control an aircraft's speed, direction and altitude in flight, etc.

To prevent unwanted stack voltage dips (due to imperfect air delivery/hydrogen delivery/humidity control/contamination/aged stack, etc.), it is desirable to design the DC/DC converter HVDC01 32 to limit conversion (in kW or current limit) based on a command from a system controller 14, as illustrated in FIG. 1. The controller 14, using instructions stored in memory 11, computes the capability in kW (or current limit) of the stack based on airflow, fuel, humidity, pressure, temperature etc. Under this scenario, the DC/DC converter HVDC01 32 will only deliver power based upon the fuel cell stack's full capacity (kW) when the compressor and fuel injectors are ready to handle the load, and not before. Under most scenarios, the DC/DC converter HVDC01, which includes current modules for limiting current output from each fuel cell, will limit power conversion to less than rated power of the fuel cell stack. The DC/DC converter HVDC01 will be commanded to convert only what the stack is capable of delivering at a given point in time. If an aircraft or a component of the aircraft instantaneously draws a larger load than the fuel cell stack can accommodate at a particular point in time, the result will be that the high voltage DC electrical bus 16 will drop to some lower voltage. This “lower voltage” can be used as a trigger for the DC/DC converter HVDC01 to start drawing power from the energy storage device 18 to augment the power provided by the stack.

The energy storage device 18 may be a battery, a flywheel, a capacitor and/or any other suitable device for storing energy. In one embodiment, the energy storage device 18 is a 144 V lead acid battery, which is used to augment the power provided to the DC/DC converter HVDC01. The energy storage device 18 generally needs to step-in before the fuel cell stack output voltage drops below a prescribed voltage. In one embodiment, the energy storage device 18 steps in preemptively at the moment (or with a nominal latency delay) that the system controller 14 calculates that the air and fuel cannot satisfy the electrical demand. This allows for the controller 14 to catch up to the electrical loads, for example by changing parameters for the balance of plant and thus giving time (e.g., time for a compressor to spool, fuel to be delivered, etc.) in order to generate the required power from the stack

There are two general types of triggers that may be used to initiate battery fill-in: 1) Fuel Cell Capability based Triggers; and 2) Voltage based Triggers.

1. Fuel Cell Capability Based Triggers

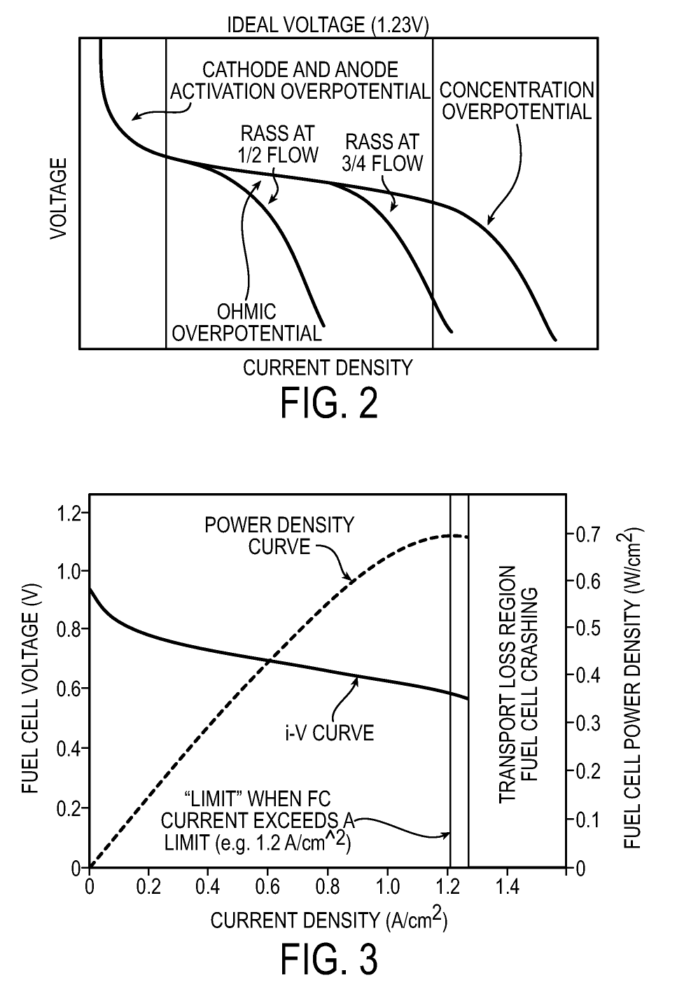

A fuel cell stack's ability to produce power and current is calculated based upon fuel cell polarization curve. Referring to FIG. 2, a polarization curve is illustrated for a reactive air system. A person having ordinary skill in the art will readily appreciate that the polarization curves illustrated in FIG. 2 are exemplary in nature and not intended to limit the scope of the present invention.

The instantaneous current (i) draw against the fuel cell is actively managed to prevent the fuel cell from exceeding its calculated limit. This “limit” is designed to accomplish two goals: 1) prevent the cathode stoichiometry ratio from falling below a predetermined floor, and 2) prevent the fuel cells from operating in the “mass transport loss region” of the polarization curve, as illustrated in FIG. 3. Active prevention may occur by commanding current limits to the multiple DC/DC converters that draw power from the fuel cell. This current limit results in two possibilities: 1) limiting the current drawn from the fuel cell when loads are high will require battery fill-in, and 2) drawing excess current from the fuel cell when the load is low will require battery charging to occur.

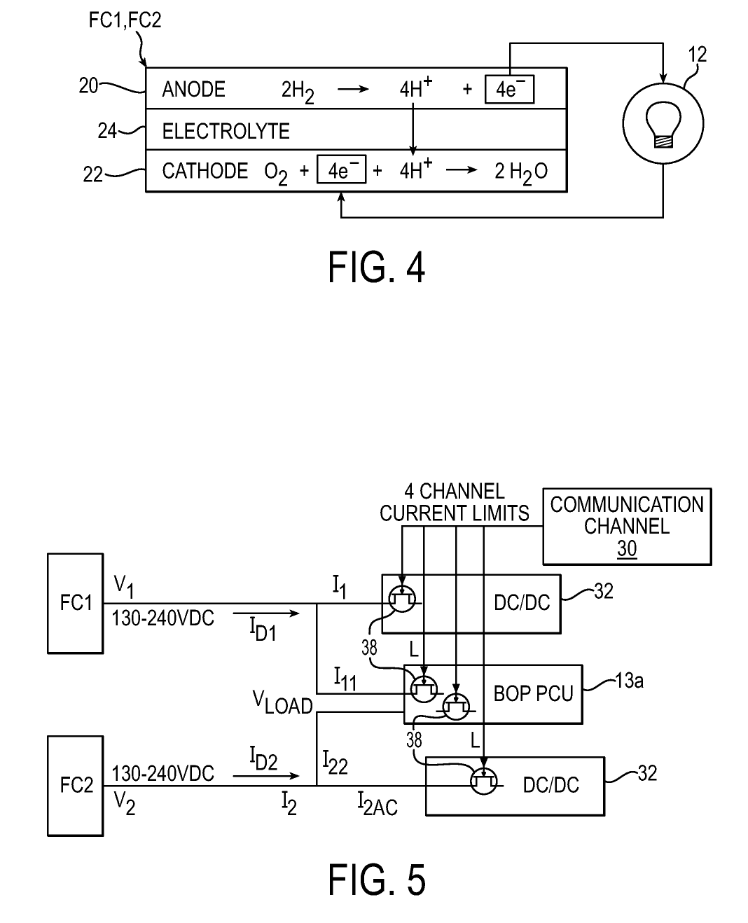

Software control prevents the stoichiometry ratio from going below a minimum floor by limiting the electrical load on the fuel cell stack based on the instantaneous hydrogen and air flows. As illustrated in FIG. 4, each fuel cell (FC1, FC2) includes an anode 20 and a cathode 22 separated by an electrolyte 24. Each oxygen molecule reacts to produce four (4) electrons of electrical current (at a stoichiometry ratio=1). Airflow sensors in FC1 and FC2 determine how much oxygen is available and the controller sets the fuel cell's current limit accordingly.

Additionally, the current is limited to prevent the fuel cell stack (FC1, FC2) from being driven beyond its “Ohmic region” and into the undesirable “mass transport loss region” of the polarization curve, illustrated in FIG. 3. The transport region is the portion of the curve where an incremental current increase results in a substantial voltage decrease such that the fuel cell stack is no longer able to power the load, thus resulting in a precipitous voltage drop. The governing control laws ensure that the total current leaving the fuel cell is limited by the multiple current limiting devices 38 within DC/DC Converter HVDC01 32 and the BOP PCU 13b (sum total 4 orchestrated by the system controller 14). Referring to FIG. 5, two fuel cell stacks (FC1 and FC2) are shown. Each fuel cell stack's electrical output can be “throttled” via current limiting device 38 within modules 32 and 13b to prevent consumers in aggregate (I_{2AC}+I₁₁=I_{D1}; I_{2AC}+I₂₂=I_{D2}) from over drawing current from their respective stack and simultaneously providing a steam of Oxygen Depleted Air with an Oxygen content tightly controlled for use in fire suppression. This can be accomplished, for example, by using the current control devices 38 within modules 32 (which are under the control of the DC/DC converter HVDC01 32) to limit the current drawn from each fuel cell. As illustrated in FIG. 5, both fuel cell stacks (FC1 and FC2) are coupled to a communication network 30 receiving commands from Master Controller 14, which is configured to provide current limit signals to the DC/DC Converter current modules 32, 13b associated with each fuel cell stack. The power level set forth by the master controller 14 for the fuel cell stacks to achieve must take into account the power required for the Balance of Plant (BOP). The BOP powers ancillary devices necessary to operate the fuel cell system. The power from the fuel cell that is not ultimately consumed by the load 12 (e.g., ID1−I1=I11; ID2−I2AC=I22) is used to provide power to the balance of plant 15 (BOP). In this regard, the BOP power converter unit 13 via current modules within BOP DC/DC 13b, controls the power flow to the BOP necessary to operate the fuel cell.

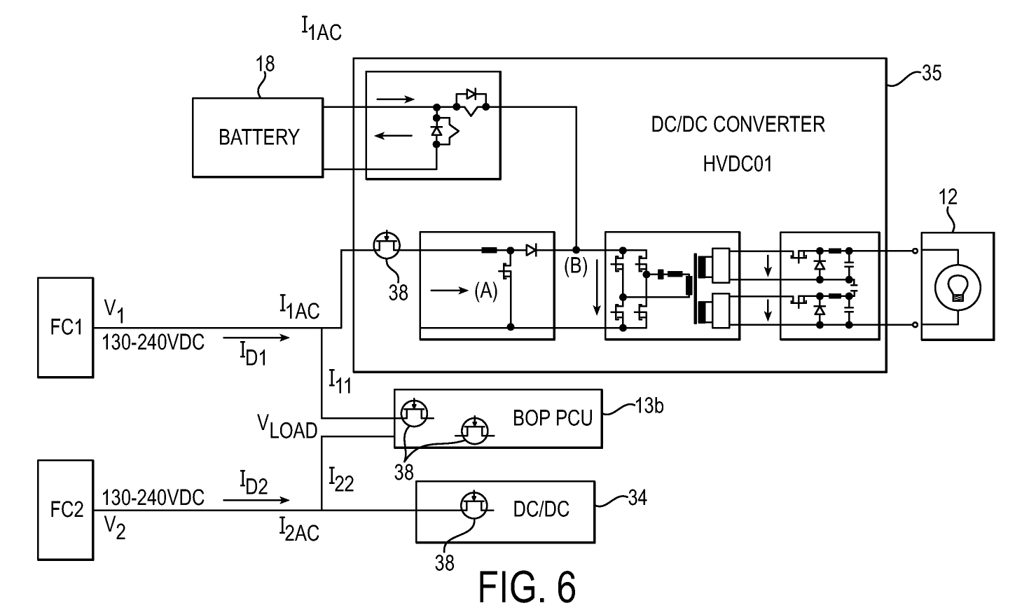

When the load 12 coupled to the fuel cell stack (FC1, FC2) attempts to use more energy than available by the fuel cell stack, the energy storage device 18 is configured to provide the needed power. The fill-in power combines with the fuel cell power to fulfill all electrical loads. In FIG. 6, DC/DC Converter HVDC01 35 is a blown-up detail of the

DC/DC Converter 32 shown in FIG. 5. Additionally, in FIG. 6, the DC/DC Converter HVDC01 34 is identical to DC/DC Converter HVDC01 35 and operates in the same way, but DC/DC Converter HVDC01 34 has detail omitted. Per FIG. 6, DC/DC Converter HVDC01 35 is coupled to both an energy storage device 18 and fuel cell stack (FC1). As an exemplary method, current limiting device 38 shown within DC/DC Converter 34 limits current thus forcing energy storage device 18 to provide fill-in power at point (B).

2. Voltage Based Triggers

In addition to the “fuel cell capability calculation” triggering fill-in power, other triggers for energy storage device intervention may also be desirable, such as triggers based on:
CVM anomalies (cell voltage monitor).
Fuel cell stack under voltage resulting from the applied load.
   These voltage triggered fill-ins not only protect the stack from crashing, but allow the system to continue operating under adverse conditions with occasional fixed short bursts of battery fill-in. The device and method in accordance with the invention provide more robust operation against adverse conditions. Adverse conditions include:
stack degradation;
intermittent contamination;
imperfect air delivery;
contamination in Hydrogen;
poor humidity control;
poor temperature control;
sensor delay, drift, and inaccuracy;
some catalyst deterioration;
random variation;
other unforeseen events;
   Since all these phenomenon result in poor fuel cell voltage, short bursts of power fill-in will prevent the fuel cell crash as long as irregular events are intermittent in nature.

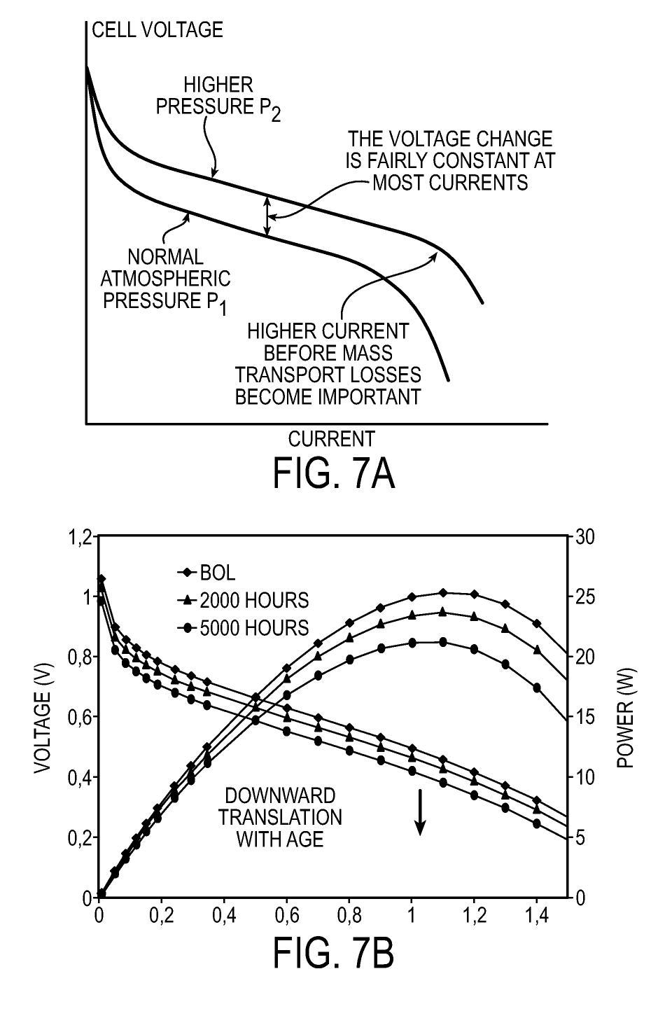

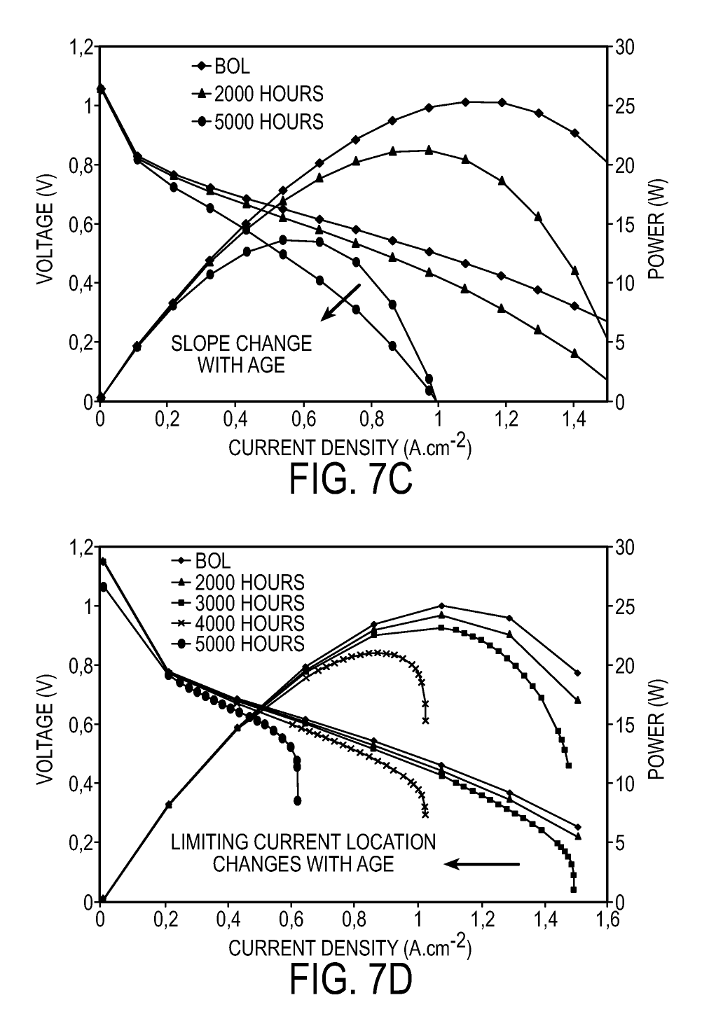

FIGS. 7A-7D illustrate various examples of anomalous fuel cell behavior, which voltage triggering and “voltage based” power fill-in are designed to abate. FIG. 7A illustrates the effect of Cathode pressure loss on the polarization curve of a typical fuel cell. The upper portion of the graph illustrates higher pressure (P2) than the lower portion of the graph (low pressure (P1), which shifts the curve downward (e.g., for a particular current, a change in pressure results in a corresponding change in voltage). A step loss in pressure resulting in a downward step voltage will trigger battery fill-in.

FIG. 7B illustrates voltage (V) and power (W) plotted over current density for the balance of load, age of 2000 hours and age of 5000 hours. As can be seen from the graphs, with increased time there is a downward translation (e.g., decreased voltage output) associated with the operational time of the fuel cell.

FIG. 7C illustrates voltage (V) and power (W) plotted over current density age at 2000 hours and age at 5000 hours. Degradation is observed where the Ohmic losses have increased over time.

FIG. 7D illustrates voltage (V) and power (W) plotted over current density age at 2000 hours and age at 5000 hours. Observed is anomalous behavior or malfunction causing a limit to gas diffusion layer capability, or potentially a limited availability of fuel cell reactants.

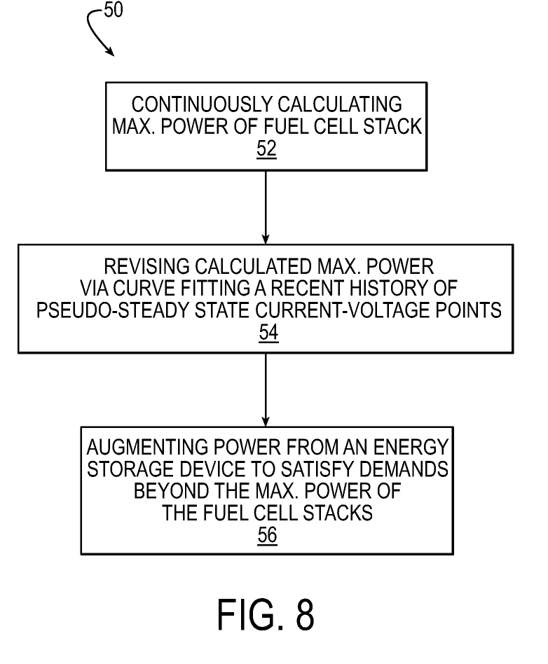

An exemplary method 50 for managing power output between a fuel cell stack (FC1, FC2) and an energy storage device 18 in an aerospace power control system 10 is illustrated in FIG. 8. The method may be executed, for example, by the controller 14 (or other device). Beginning at block 52, the method continually calculates a maximum power each fuel cell stack (FC1, FC2) is capable of supplying to an associated load 12 of an aerospace vehicle. Such calculation may be based on curve fitting recently acquired steady-state current-voltage points. Next at block 54, steady state current and voltage points of a fuel cell stack are continuously being acquired, thus updating and revising the recent historical record of the polarization curve. A revision of the polarization curve and the knee of the curve representing the maximum power of the fuel cell is continually being updated. Monitoring may be performed in any desired manner using conventional current monitoring and/or voltage monitoring devices (e.g., current and voltage sensors and the like).

At block 56, if the associated load 12 seeks an amount of power greater than the maximum power the fuel cell stack (FC1, FC2) is capable of supplying, additional power is selectively output from the energy storage device 18 to augment the power provided by the fuel cell stack. The method 50 may optionally include limiting power and/or current output from each fuel cell stack (FC1, FC2) to a prescribed value, wherein the prescribed value is selected to prevent a cathode stoichiometry ratio associated with the fuel stack from falling below a prescribed value.

The method 50 of FIG. 8 may function to prevent a fuel cell stack from outputting power and/or current to an associated load prior to the fuel cell stack reaching a desired operating temperature. A solution for a cold starting fuel cell may involve the controller 14 initializing the polarization curve to a very low level, which might be typical of a very cold fuel cell performance. More particularly, when a fuel cell is first started it can be difficult to provide stable rated power until the fuel cell has reached normal operating temperature. Upon initializing the polarization curve to a very low level, the knee of the curve will be very far to the left, thus setting a current limit for the fuel cell stack to near 0 Amps, above which triggers power fill-in from the energy storage device 18. For example, for cold start warm-up, the BOP's current limits can be set to near zero, forcing predominantly battery operation. As it warms, the fuel cell stack is progressively un-throttled as it starts to revise a historical record of current-voltage measurement pairs which are trending upwards in voltage towards representing a warm fuel cell polarization curve. As the knee of the curve trends rightwards indicating more current is available from fuel cell, the continuously calculating maximum power of the fuel cell at block 52 increases, allowing more energy from the fuel cell and less augmentation from the energy storage device to satisfy demands of the system beyond the maximum power of the fuel cell stacks at block 56. As the method 50 allows the fuel cell to actively probe and update the knee of the curve, this minimizes the overall battery draw for the warm-up process and is based upon the true capability of the fuel cell.

During start-up of a fuel cell in cold temperatures, the energy storage device can be used to externally and actively warm the system before a fuel cell start-up routine is attempted. The power from the energy storage device 18 can provide power to a balance of plant (BOP) and actively warm the fuel stack to a first operating temperature. The power provided from the BOP is proportionately switched away from the energy storage device and loaded onto the fuel cell stack based upon distribution of voltage measurements from a plurality of cell voltage monitors until the energy storage device is reliably offloaded. The BOP is powered with the fuel cell stack while recharging the energy storage device until the desired operating temperature of the fuel cell stack is reached, wherein upon reaching the desired operating temperature, power and/or current is output from the fuel cell stack to power the associated load.

To encourage a start-up without excessive water condensation and shock loading cycles, a progressive gentle electrical loading of the fuel cell can be done by actively managing that the voltage of the multiple cell voltage monitors (CVM) to stay within a nominal distribution. When a single CVM monitor strays lower than the rest, this triggers the control system to retreat back to fill-in power provided by the energy storage device 18 and unload the fuel cell. The process is retried again until successful loading has occurred. This achieves the best cold start performance in terms of the critical battery cold cranking capacity in Amp-Hours.).

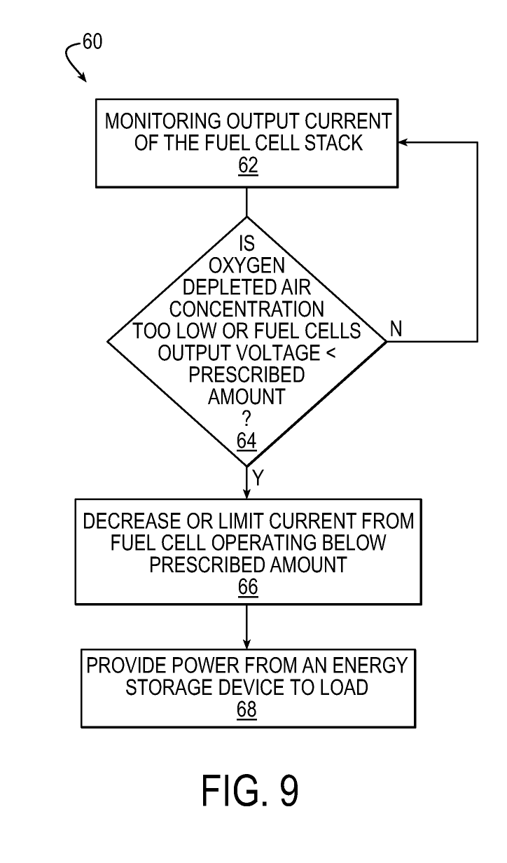

Another exemplary method 60 for managing power output between a fuel cell stack (FC1, FC2) and an energy storage device 18 in the aerospace power control system 10 is illustrated in FIG. 9. Beginning at block 62, the method includes monitoring output current form the fuel cell stack (FC1, FC2), wherein the fuel cell stack is providing power and/or current to an associated load 12 of the aircraft system, the associated load of the BOP BUS 13d, and net power and/or current to battery 18.

At block 64, a determination is made as to if oxygen depleted air used as fire suppression gas which is being measured at the exhaust of the fuel cell is at a concentration too low or too high or alternatively if one or more of the fuel cells (FC1, FC2) have an output voltage less than or greater a prescribed threshold of voltage output from one or more other fuel cells in the fuel cell stack.

At block 66, the controller is configured to decrease current from the fuel cell stacks using the plurality of current limiting devices 38.

At block 68, the controller is configured to deliver or cause to deliver power and/or current from the energy storage device 18 to the associated load 12 if the fuel cell stack output voltage from the one or more other fuel cells in the fuel stack is greater than or less than the prescribed threshold of voltage or if oxygen depleted air percentage is not the prescribed value.

The method 60 may further include performing a remedial action on the one or more fuel cells having an output voltage greater than or less than the prescribed threshold of voltage output. Such a remedial action includes holding fuel cell limits while purge of the cathode individually, purge of the anode individually, or simultaneously purging the cathode and anode, shutting down the fuel cell completely, sending an alarm and/or other indication regarding the status of one or more fuel cells, for example.

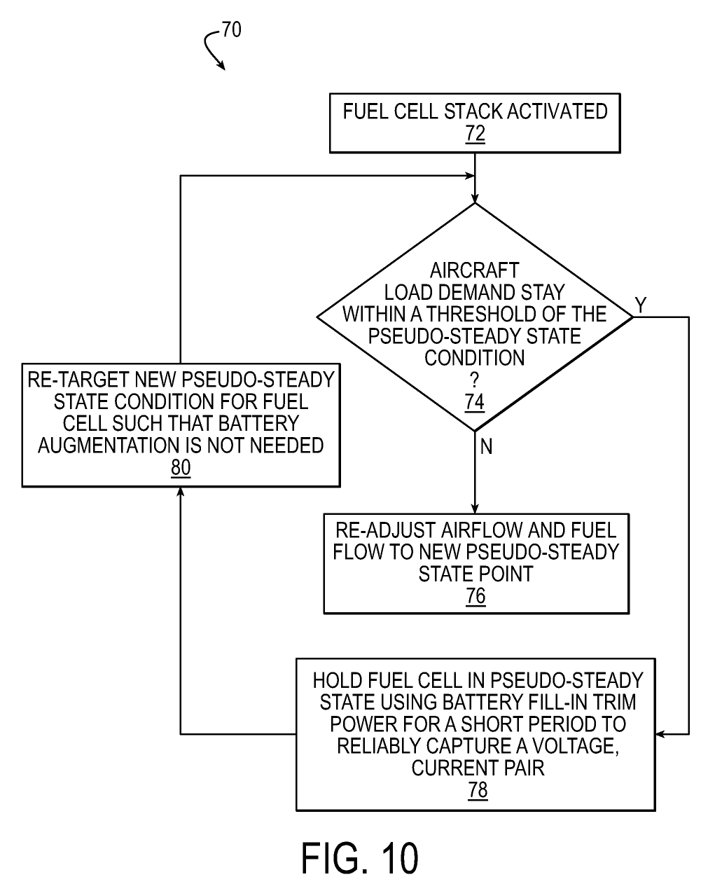

Another exemplary method 70 for managing power output between a fuel cell stack (FC1, FC2) and an energy storage device 18 in the aircraft system 10 is illustrated in FIG. 10. At block 72, the fuel cell stack (FC1, FC2) has finished initialization and actively providing power to a load 12. At block 74, it is determined if aircraft load demands stay within a pseudo-steady state condition such that battery fill-in could reasonably be used to augment the loads during small system load changes. More particularly, if the aircraft system loads deviate from a steady state condition where it is not reasonable for battery to provide fill-in trim power, at block 76 a re-adjustment of airflow and fuel flow to a new pseudo steady state condition. If the aircraft system loads continue to stay within a pseudo steady state threshold, the decision at block 74 is affirmative and signal control moves to block 78 where output power from the fuel cell stack forcefully held in steady state in terms of airflow, fuel flow, and power demand. During this short duration, small perturbations in system loads are satisfied by battery augmentation, providing fill-in trim power for the system. This slight charging and discharging of the battery also serves to warm the battery chemistry for optimal operating performance. Once a voltage-current point on the polarization curve is stored away in the system controller 14, a new pseudo steady state condition is calculated and re-targeted in block 80 and the process is allowed to repeat itself by going back to block 74.

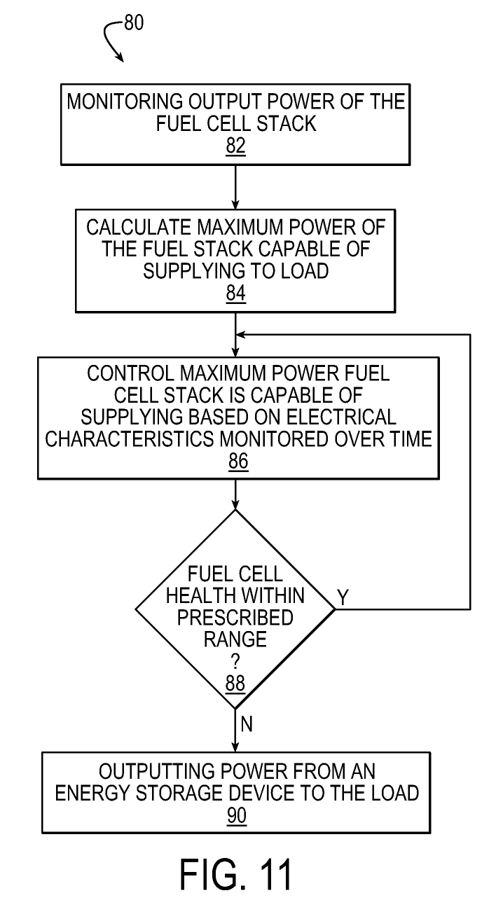

FIG. 11 illustrates an exemplary method 80 in accordance with aspects of the present invention. The method 80 is directed for operating a fuel cell stack FC1, FC2 in an aircraft system 10. At block 82, the method includes monitoring electrical characteristics associated with the fuel cell stack over time, wherein the fuel cell stack is a component of the aircraft system. The data monitored may be stored in a memory 11, which may take any suitable form. The electrical characteristics may be monitored by any current, voltage and/or power monitoring device.

The memory 11 may be directly or indirectly coupled to the controller 14. The electrical characteristics associated with the fuel cell stack may be stored in memory 11. The data stored may be actual data from monitoring the fuel cell stack. In addition, the memory may also include reference data suitable for comparing with the stored electrical characteristics to determine health of the fuel cell stack. The health of the fuel cell stack may be determined in any desired way. For example, an algorithm that takes into account reference and monitored data may be used to determine health. In another embodiment, the memory 11 may include reference data suitable for comparing with the monitored and stored electrical characteristics of the fuel cell stack to determine anomalous behavior associated with the fuel cell stack.

At block 84, the controller 14 (or other processing device) calculates a maximum power the fuel cell stack is capable of supplying to an associated load 12 of the aircraft system. As discussed above, the maximum power may vary as a function of variation of electrical characteristics monitored over time.

At block 86, the controller 14 controls the maximum power and/or current the fuel cell stack is capable of supplying to an associated load based on the variation of electrical characteristics monitored over time.

At block 88, a determination is made as to the health of the fuel cell stack. As stated above, the health of the fuel cell stack may be determined in any desired way.

For example, an algorithm that takes into account reference and monitored data may be used to determine health. In another embodiment, the memory 11 may include reference data suitable for comparing with the monitored and stored electrical characteristics of the fuel cell stack to determine anomalous behavior associated with the fuel cell stack. For example, if the fuel cell stack is operating within a prescribed range based on the electrical characteristics monitored over time, the process flow continues to block 86.

If a determination is made at block 88 that the fuel cell stack is operating outside of the prescribed range, at block 90 the method 80 further includes supplying power from an energy storage device 18. As stated above, the energy storage device 18 may be any device capable of storing power and providing the power as needed by the aircraft system when the demand exceeds the capability of the fuel cell stack. For example, the energy storage device may be a battery, a flywheel, a capacitor, etc.

The functionality described in the above methods may be performed by one or more controllers. The controller is generally configured to make power available from the fuel cell stack (FC1, FC2) and/or the energy storage device 18 to the associated load.

This concept of coordinated fuel cell (FC1, FC2) and battery 18 control has the following benefits:
1) coordinate power of a fuel cell stack with battery augmentation in a technically elegant modeled based manner;
2) increases system robustness by eliminating fuel cell “stack crashing” by preventing the fuel cell from entering into its undesirable “mass transport loss” region, which would damage the fuel cell;
3) reduces fuel cell stack degradation by protecting the fuel cell stack from electrical transient shock loads;
4) increased operational robustness by periodic power fill-in on stack under-voltage and Cell Voltage Monitor (CVM) anomalies;
5) prevents the fuel cell from being pulled below the predetermined cathode stoichiometric “floor” ratio during transient electrical loading;
6) provides robustness against random variation via detection of abnormal voltages triggering power fill-in to prevent fuel cell crash;
7) allows consistent fuel cell power by compensating for fuel cell anomalies with variable power fill-in;
8) precise transient control of a fuel cell's cathode stoichiometry ratio necessary for generating fuel tank inerting gas, which is done by the addition of rapid throttling of electrical current instead of relying solely on the response of the air compressor.

Inert Gas Generation

In accordance with one aspect of the invention, the fuel cell stack is operated in oxygen-depleted air (ODA) mode to generate oxygen-depleted air in the fuel cell stack exhaust. The ODA produced at the cathode exhaust can be pumped into a fire suppression system of the aircraft and/or into the ullage of fuel tanks (as an inert gas). In this manner, the fuel cell stack can provide multiple functions (e.g., power generation and fire suppression), thereby saving space and weight that may be associated with two separate systems.

In ODA mode the fuel cell stack, which may have a varying load, is controlled to coordinate a measured inlet airstream flow rate with a “current limit” mechanism to create an exhaust airstream from the fuel cell stack that has precise oxygen percentage by volume (e.g., 11% oxygen).

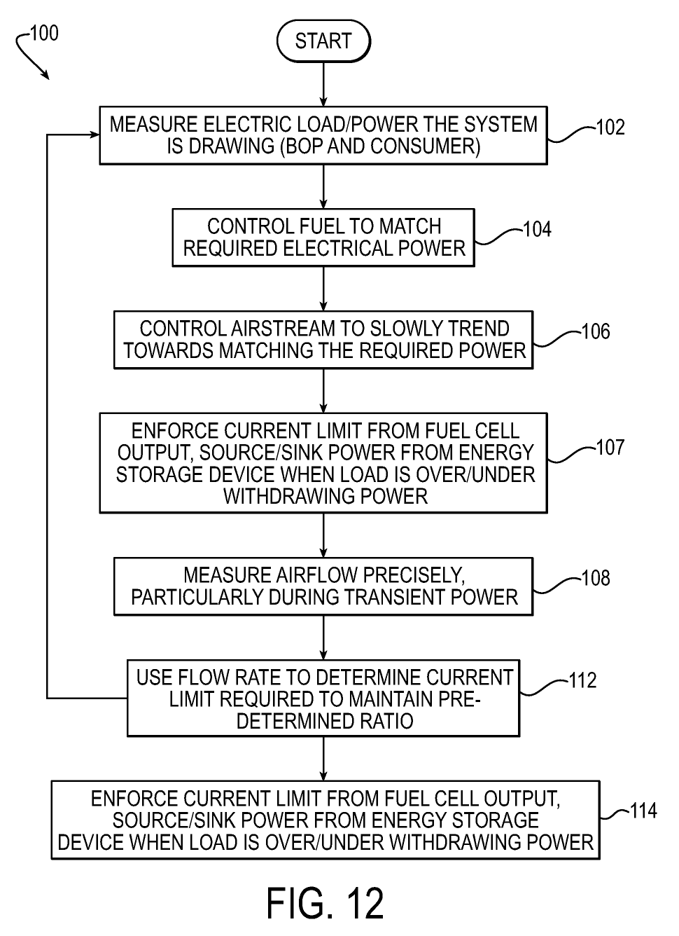

Referring to FIG. 12, illustrated is a method 100 for generating ODA in accordance with an embodiment of the invention, where an airstream having a known 21% oxygen content from earth atmosphere is provided to the fuel cell stack. Beginning at block 102, a measure of electrical load/power drawn from the fuel cell stack is made, for example, using current and voltage sensing devices. The measured values then are provided to the controller 14. Such load/power measurement includes the power required to run the BOP (balance of plant) and to power the load which the system is designed to serve.

At block 104 the controller commands the fuel side in the anode of the fuel cell to match the electrical load. At block 106, the airstream flow rate is commanded by the controller 14 to change at a reasonable rate to meet the aircraft requirements as well as the requirements of the balance of plant (BOP) loads. Thus, for example, if additional power is needed from the fuel cell stack the fuel and airstream flow rate may be increased, and if less power is needed from the fuel cell stack the fuel and airstream flow rate may be decreased. Control of the airstream flow rate may be via an aircraft bleed inlet valve or via a traditional compressor under the supervision of the controller 14.

The rate of change in which the controller 14 increases the airstream should be well managed, as from the fuel cell's point of view an increase in aircraft load may be made worse by the additive increase in power draw of the BOP compressor required to pump more air into the fuel cell. Both increases in power at the same time can cause an overloading effect on the fuel cell if not protected by a current limit device. In this regard, the controller 14 may generate a command signal indicative of a desired airstream flow rate. The signal then may be provided to an actuator or other device that manipulates the bleed inlet valve or compressor to achieve the desired airstream flow.

Since the airstream actuator for controlling airflow has a slow response, at block 107 the current supplied by the fuel cell stack to the aircraft and BOP loads will be limited via the DC/DC converter HVDC01 and associated current modules 32 during situations when additional power is required from the fuel cell stack. In this manner, the stack is not subjected to excessive power draw as the system transitions to produce the required power output. During this transition period, the energy storage device 18 is used to augment the power output of the fuel cell stack as indicated at block 107.

In generating power from the fuel cell stack, the system is controlled such that the exhaust stream remains at a prescribed value (e.g., 11% oxygen depleted exhaust). A fuel cell will operate effectively at stoichiometric ratios above 1.6. At a ratio of about 1.6-1.4 the fuel cell is somewhat suffocated but can still operate, while at levels below 1.4 to 1.2 the system will generally not operate. To prevent the ratio from dropping below 1.6, the current output of the stack in proportion to the measured inlet airstream flow is controlled to achieve the desired oxygen concentration in the exhaust. Preferably, the stoichiometric ratio is regulated between 1.6 and 1.8. By limiting current (e.g., by using the aggregate of the 4 limiters shown in FIG. 3) and by controlling the inlet airstream flow, precise control of the stoichiometric ratio can be achieved such that ODA having a prescribed oxygen content is obtained. This oxygen depleted air is sufficiently low to produce fire suppressant quality air. In addition, to further enhance control of the fuel cell, for conditions when projected current limits fail to prevent voltage from dropping too low, a “synthesized” software voltage limit can be imposed using the underlying fast acting (within 100 micro-seconds) hardware current limit.

Moving to block 108 a measurement is made for the flow rate of the inlet airstream used by the fuel cell stack to produce the required power. The inlet airstream flow rate may be measured, for example, using a mass airflow sensor or the like. The measured flow rate then can be provided to the controller 14. Next at block 112, based on the measured airstream flow rate and the desired stoichiometric ratio, the current output by the fuel cell stack that will produce the desired ODA is determined.

In one embodiment the current output is determined using a lookup table or the like. In this regard, the lookup table may include a number of different airstream flow rates and the corresponding fuel cell “current” output for that flow rate that will produce a stoichiometric ratio of 1.8 (or other desired ratio) while fuel delivery is constant. Thus, for a measured airstream flow rate the current output from the fuel cell that will achieve a stoichiometric ratio of 1.8 can readily be retrieved. In another embodiment, the required current for producing the desired stoichiometric ratio can be calculated based on the measured airstream flow rate and the desired stoichiometric ratio.

The desired Stoichiometric Ratio for the control system to target would be given by the formula

$$SR = \frac{{X}_{ODA} - 1}{{X}_{ODA} * K + {X}_{ODA} - 1}$$

where X_{ODA} is the mole fraction of Oxygen in dry air required to suppress fire (for example, a value of 0.11), and constant K is the ratio of Nitrogen to Oxygen in earth atmosphere

$$( \frac{{n}_{N {2}_{air}}}{{n}_{O {2}_{air}}} = \frac{79}{21} ) .$$

Once the stoichiometric ratio has been determined, the current limit can be precisely controlled with fast acting hardware, where current is determined using the formula

$$I = ( \frac{{\dot{m}}_{in}}{{MW}_{in}} ) \frac{4 F}{SR ( 1 + K )}$$

where F is the Faraday constant, \dot{m}ᵢₙ is the mass flow of air into the fuel cell (measured by an ordinary mass airflow sensor), and MWᵢₙ is the molecular weight of input gas (assumed dry earth air, 79% Nitrogen, 21% oxygen).

Having obtained the current output that will produce the desired stoichiometric ratio for the measured airstream flow rate, next at block 114 the current output by the fuel cell is limited to the determined current value. In limiting the current output from the fuel cell stack, the controller 14 may communicate the desired current value to the DC/DC converter HVDC01, which in turn will command the current modules 32 and 13a to limit the current output of each fuel cell to the desired value.

Accordingly, by limiting the current output by the fuel cell stack based on the airstream flow rate and a predetermined stoichiometric ratio, precise control of the oxygen content output at the fuel cell exhaust can be achieved.

### Constructing Actual Performance Curve Using Current Limit to Hold for Sampling

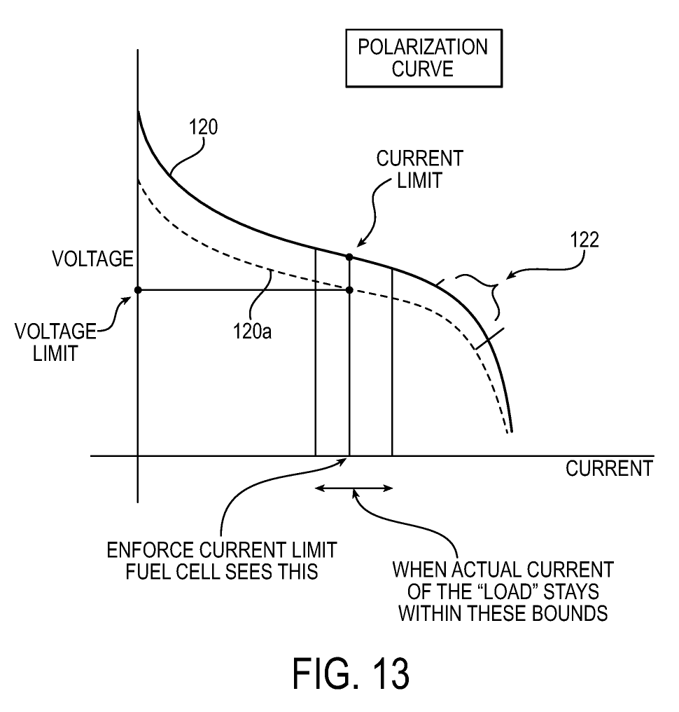

The output characteristics of a fuel cell stack can be described in terms of output current and output voltage. FIG. 13 illustrates a plot of the output current and voltage for a fuel cell, the plot often referred to as the polarization curve 120. The portion of the curve to the left of the knee 122 is referred to as the ohmic region, while the portion of the curve to the right of the knee 122 is referred to as the mass transport loss region. Since operation of the fuel cell in the mass transport loss region can lead to precipitous loss of voltage and/or fuel cell damage, it is highly desirable to prevent the fuel cell from operating in this region.

To determine the operating region of the fuel cell stack, the voltage and current output by the stack can be measured and plotted on the polarization curve 120, as shown in FIG. 13. If the fuel cell stack is operating in the mass transport loss region or near the mass transport loss region (e.g., on the knee 122), the power output of the stack should be adjusted downward (less power output from the stack) to shift the operating region to the left of the knee 122.

Preferably, for more robust operation, the fuel cell stack will proactively ascertain where the knee is and stay away from operating past the knee. However, operating near the knee of the curve is beneficial, as the peak power point for the fuel cell is located at the end of the ohmic region, just shy of the mass transport loss region.

Typically, the polarization curve for a fuel cell is determined at the time of manufacture and stored in memory 11 of a controller 14. The controller 14 can reference the curve to control the operation of the fuel cell stack. However, during periods of contamination, water imbalance conditions, aging, or other anomalous conditions, the fuel cell stack may be degraded and the polarization curve derived when the stack was new may no longer accurately describe the operation of the stack. This can be problematic, as the controller 14 may not be able to accurately determine where the knee of the polarization curve is. Since the knee of the polarization curve indicates where the fuel cell can produce maximum power, the negative consequence may be that the controller 14 may try to operate beyond the maximum power of the fuel cell, which can cause a precipitous voltage drop and damage to the fuel cell.

In accordance with an aspect of the present invention, the degradation of the fuel cell stack is approximated and a new polarization curve 120a constructed in real-time. The new polarization curve accurately describes operation of the fuel cell stack in its degraded state. In this regard, the controller 14 probes for the knee 122 of the polarization curve 120 by performing a number of hold and sample steps, where airflow and an associated limit of electrical current from the fuel cell are stepped in a pseudo steady state manner. The data obtained during such process then is used to approximate, via a curve fitting technique or other technique, the instantaneous polarization curve, and estimate the location of the knee 122. The controller 14 shall not command the fuel cell beyond the instantaneous maximum power point.

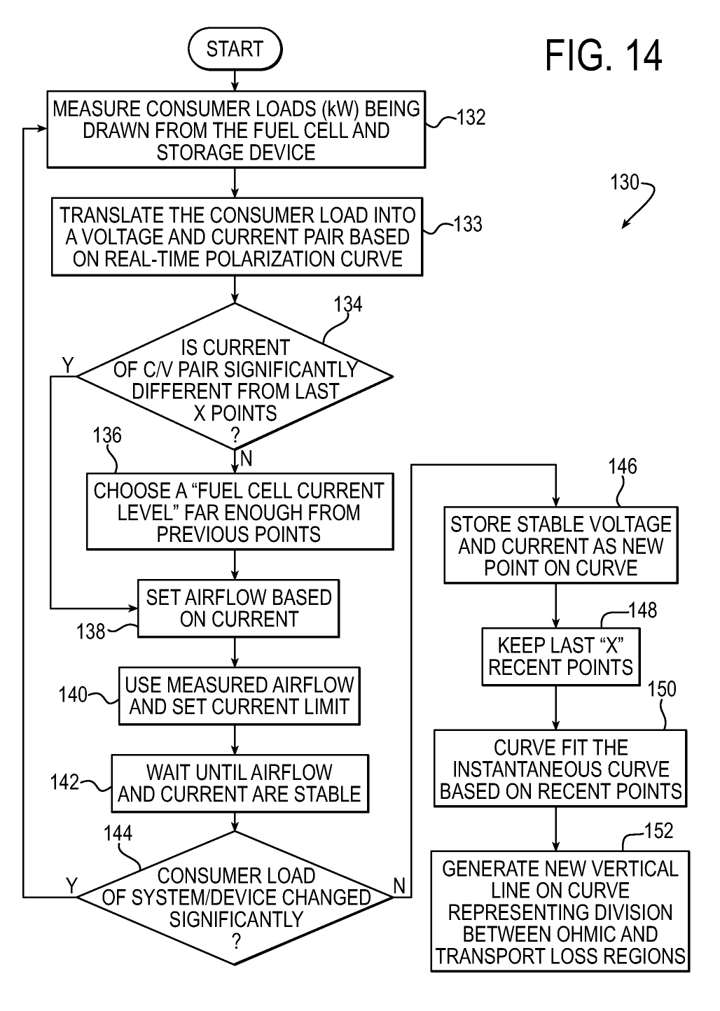

Referring to FIG. 14, illustrated are exemplary steps for a method 130 of approximating a polarization curve of a fuel cell/fuel cell stack in accordance with aspects of the invention. Beginning at block 132, the controller 14, via voltage and current sensors, measures the aggregate consumer load (kW) which the aircraft consumers and BOP are drawing from the system. This measurement identifies the power that the combined fuel cell and storage device (e.g., battery) must provide to satisfy electrical consumers. Controller 14 will set the allocation of power between the fuel cell and storage device in the following blocks.

At block 133 the controller 14 translates the consumer load (kW) to a voltage and current pair by looking up the load on the real-time polarization curve developed from previous loop iterations. At block 134, controller 14 compares the current (Amps) against the current of last several current/voltage pairs stored during the hold and sample processes. If the consumer load projects that current will not be significantly different (i.e., close such as within 2 percent of the fuel cell current range) to the current stored in the last several points, then the method moves to block 136. In block 136, an electrical current (Amps) is chosen such that it is unique, giving the curve fitting approximation enough meaningful points to provide a satisfactory real-time polarization curve approximation. Once fuel cell current is selected in block 136 it is intended to force the fuel cell into steady state in terms of airflow, fuel flow and power draw for a duration long enough to capture and store a valid current/voltage pair. During this time, so long as consumer load in block 144 has not changed, augmentation from a battery 18 will be used to fill-in slight changes in the overall system loads. This will ensure fresh current/voltage points are continually being produced, such that a curve fit of the last several current/voltage points can create the instantaneous fuel cell polarization curve, and thus determine the true knee of the polarization curve in real-time. The choice to modify the current upwards or downwards in block 136 depends on a number of factors such as, but not limited to: whether charging or discharging is beneficial to the storage device at the given time, minimizing the storage device's power contribution, providing a point far enough away from existing points to allow the curve fitting process to generate a real-time polarization curve with high confidence and trustworthiness, etc.

The method then moves to block 138 as discussed below. Moving back to block 134, if the current is significantly different from the other current points stored in the last several hold and sample processes, the method moves directly to block 138 where current will be used to set the airflow in block 138. At block 138, an airflow (\dot{m}) is selected to satisfy the targeted current the fuel cell will supply. The current is transformed into an airflow (\dot{m}) by using a prescribed stoichiometric ratio and ODA % along with the formulas described above concerning regulation of ODA. Formulas were provided herein as a transformation from airflow (\dot{m}) to current (Amps), but a person having ordinary skill in the art can derive the opposite case where airflow is derived from current. Once the required airflow is determined, controller 14 commands the required airflow to the fuel cell stacks (FC1, FC2). For example, the controller 14 may generate a signal commanding the air bleed (or compressor) to provide a desired airflow to the fuel cell.

In block 140, controller 14 reads the momentary airflow (\dot{m}), and a signal commanding the DC/DC converter HVDC01 to limit current output from the fuel cell stack. The calculation from momentary airflow (\dot{m}) to current limit (Amps) is given in the forward direction in the formulas above. This current limit has quick response time, and is commanded lock-step to the measured airflow, which is transitioning relatively slowly. As the airflow and current at any given moment remain tightly coupled, this generates a precise stoichiometric ratio and precise ODA concentration at all times. The current limit obeys the knee-of-the-curve limit, to prevent excess power from being drawn from the fuel cell stack.

An airflow which is intended to be held constant for the hold and sample time may have relatively large delays due to lag times required to spool-up a compressor or open or close bleed air valves. At block 142 after a slight delay to allow the airflow of the fuel cell to stabilize, a hold timer begins so that a sample measurement of the voltage/current pair of the fuel cell is obtained. After the delay time has elapsed, the method moves to step 144 where it is determined if the measured consumer loads (kW) of the system or device which the fuel cell and energy storage device (e.g., battery) are powering change significantly (e.g., 10 percent change in the measured consumer load). If so, the hold-and-sample point is abandoned so that battery is not sourcing or charging at rate which is undesirably high and the method moves back to block 132. This change to the consumer load can be deemed too high when any of following non-limiting examples occur: the storage device (e.g., battery) is not capable of making up the difference, the storage device is too cold, etc. When this abandonment occurs, the airflow will re-target and re-acquire a new level to match the true consumer load (kW). If at block 144 the consumer load does not change too significantly within the hold and sample time, the method moves to block 146 where a stable voltage and current are stored as new points on the polarization curve.

Next at block 148, the newest and freshest data points are retained for determining the instantaneous health of the stack. Therefore, as new points come in, older points are purged. At block 150, a curve fitting technique is implemented to characterize the most recent polarization curve based upon the last several points. A weighting factor for each point may be used in the curve fitting process. The weighting factor can be implemented in various ways, non-limiting examples of which include: giving more weight to samples that are more recent in time, and giving more weight to points that have a small standard deviation across the sample time.

From the constantly updating polarization curve, a new vertical line is calculated at block 152 to indicate the knee-of-the curve. This vertical line on the polarization curve represents the point beyond which the fuel cell should not operate and represents the maximum power the fuel cell may achieve without risking precipitous fuel cell voltage drop or other operational problems. After successful hold and sample point is stored, and a new knee-of-the curve is found, the process moves back to block 132 and repeats, thus running continuously in real-time.

Accordingly, the method of FIG. 14 enables degradation of the fuel cell stack polarization curve to be approximated, which allows the controller 14 to more accurately predict the boundary between the ohmic and mass transport loss region of the fuel cells stack. This can prevent inadvertent operation of the fuel cell stack in the mass transport loss region and/or prevent damage to the stack. In addition, the method of FIG. 14 can be used concurrently with the method of FIG. 12 to simultaneously provide both 1) a good stream of exhaust air as well as 2) identify health of fuel cell by actively probing for the knee of the curve and preventing a consumer (aircraft) load from over withdrawing and a precipitous voltage drop of the fuel cell stack.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, parts, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A fire suppression system for producing oxygen-depleted air, comprising:
a fuel cell stack formed from a plurality of fuel cells for providing power to an associated load; and
a controller coupled to the plurality of fuel cells, wherein the controller is configured to regulate current output from the plurality of fuel cells to maintain a percentage of oxygen in an exhaust of the plurality of fuel cells at a prescribed level to produce oxygen-depleted air.

2. The system according to claim 1, wherein the controller is configured to maintain a stoichiometric ratio at the plurality of fuel cells to a prescribed level.

3. The system according to claim 1, wherein the controller is configured to maintain the ratio between 1.2 and 2.0.

4. The system according to claim 1, further comprising a DC/DC power converter coupled between a power output of the fuel cell stack and the associated load, the DC/DC power converter including a current limiter to limit a current output from the fuel cell stack, wherein the controller is configured to provide a control signal to the DC/DC power converter to limit an amount of current drawn by the associated load from the fuel cell stack.

5. The system according to claim 1, wherein the controller is further configured to regulate air flow into the plurality of fuel cells to provide a variable power output to the associated load.

6. The system according to claim 1, further comprising at least one of a compressor or a bleed inlet valve for regulating air flow through the plurality of fuel cells, wherein the controller is configured to provide a control signal to the at least one of the compressor or the bleed inlet valve to regulate the air flow.

7. The system according to claim 1, wherein the system further comprises an energy storage device, and the controller is configured to:
calculate at least one of a maximum power or maximum current the fuel cell stack is capable of supplying to the associated load; and
selectively receive additional power or current from the energy storage device when the associated load seeks an amount of power or current greater than the maximum power or maximum current the fuel cell stack is capable of supplying.

8. The system according to claim 7, wherein the fuel cell stack and the energy storage device are coupled in parallel to a direct current to direct current (DC-DC) converter that is coupled to the associated load.

9. The system of claim 1, wherein the associated load comprises one or more aircraft systems.

10. A method for providing oxygen depleted air from a fuel cell stack formed from a plurality of fuel cells, the method comprising regulating current output from the plurality of fuel cells to maintain a percentage of oxygen in an exhaust of the plurality of fuel cells at a prescribed level to produce oxygen-depleted air.

11. The method according to claim 10, wherein regulating includes maintaining a stoichiometric ratio of the plurality of fuel cells to a prescribed level.

12. The method according to claim 11, wherein maintaining includes maintaining the ratio between 1.2 and 2.0.

13. The method according to claim 10, further comprising regulating air flow into the plurality of fuel cells to provide a variable power output to the associated load.

14. The method according to claim 10, further comprising:
calculating at least one of a maximum power or maximum current the fuel cell stack is capable of supplying to the associated load; and
selectively receiving additional power or current from an energy storage device when the associated load seeks an amount of power or current greater than the maximum power or maximum current the fuel cell stack is capable of supplying.

15. The method according to claim 1, wherein the associated load comprises one or more aircraft systems.

16. A method for revising a polarization curve model for a fuel cell, comprising:
a) providing a prescribed air flow through the fuel cell satisfying a load with a combination of the fuel cell and storage device;
b) upon the fuel cell reaching a steady state condition, measuring a current and voltage output by the fuel cell for the prescribed air flow;
c) determining if the measured voltage and current is indicative of a knee of a curve; and
d) upon the measured voltage and current not being indicative of a knee of a curve, incrementing the prescribed air flow through the fuel cell and repeating steps b) though d).

17. The method according to claim 16, wherein measuring the current and voltage output further includes:
storing at least one additional current and voltage point;
curve-fitting a new polarization curve using the at least one additional current and voltage point; and
preventing the fuel cell from delivering beyond the knee of the curve.

18. The method according to claim 16, wherein upon multiple measured voltage and current points defining a knee of a curve, revising a location of the knee in the polarization curve based on the multiple measured voltage and current points defining the knee of a curve.

19. The method according to claim 16, wherein determining if the multiple measured voltage and current points define a knee of a curve includes concluding the multiple measured voltage and current points are indicative of a knee of a curve when a plot of each measured voltage and current point changes slope by a prescribed value.

20. The method according to claim 19, wherein the slope is less than −1 volts/amp.
